(19) United States
(12) Patent Application Publication
(10) Pub. No.: US 2014/0115229 A1
(43) Pub. Date: Apr. 24, 2014

(54) METHOD AND SYSTEM TO REDUCE SYSTEM BOOT LOADER DOWNLOAD TIME FOR SPI BASED FLASH MEMORIES

(71) Applicant: LSI CORPORATION, Milpitas, CA (US)

(72) Inventors: Srinivasa Rao Kothamasu, Bangalore (IN); Debjit Roy Choudhury, Bangalore (IN); Sreenath Shambu Ramakrishna, Bangalore (IN); Ravindra Bidnur, Bangalore (IN)

(73) Assignee: LSI CORPORATION, Milpitas, CA (US)

(21) Appl. No.: 13/656,571

(22) Filed: Oct. 19, 2012

(51) Int. Cl. G06F 12/02

(52) U.S. Cl. 711/103; 711/E12.008

(57) ABSTRACT

Method and system for providing increased frequency of flash memories compatible to Serial Peripheral Interface (SPI) bus protocol by delayed data capturing so that system boot loader down load time reduces for a given memory configuration. Methods and systems are provided for operating the memory at the device rated frequency.

### BACKGROUND OF THE INVENTION

A Serial Peripheral Interface bus is a synchronous serial data link standard that generally operates in a full duplex mode. Devices generally communicate in a master/slave mode where the master device initiates the data frame. Multiple slave devices can be manipulated with a singular Master device. Multiple devices are allowed to have slave select lines. An SPI can be a four-wire serial bus. If a single slave device is used, an SS pin can be fixed to a logic that selects the single slave. Some slaves require a falling edge (high to low transition) of the chip select to initiate an action. To begin a communication, the bus master will first configure the clock, using a frequency less than or equal to the maximum frequency the slave device supports. Such frequencies are commonly in the range of 1 to 100 MHz, for example. Flash memories compatible to Serial Peripheral Interface (SPI) bus protocol use the falling clock edge for launching data and the rising clock edge for capturing data. Flash memories are often interfaced with an on-chip device and it is often not possible to operate the memories at highest device frequency due to memory clock to Q, chip pad delay and combinational logic inside the chip. In conventional methods, the memory operates at lower frequency based on the read data path delays and not at a device rated frequency.

### SUMMARY OF THE INVENTION

An embodiment of the invention may therefore comprise a system for capturing data when a flash memory is interfaced with on-chip devices, the system comprising a flash memory with a read-data output and an on-chip capture register, wherein the memory operates on a master clock and the capture register operates on a peripheral clock, the peripheral clock operating at a higher frequency than the master clock and synchronous to said master clock, and read data is captured by the capture register on a cycle of the peripheral clock when the master clock is high and read data is available at the capture register.

An embodiment of the invention may further comprise a method of capturing data when a flash memory is interfaces with on-chip devices, the method comprising operating the memory with a master clock, operating a capture register located on-chip with a peripheral clock and capturing read data by capture register on a cycle of the peripheral clock when the master clock is high and read data is available at the capture register, wherein the peripheral clock is synchronous with the master clock and operates at a higher frequency than the master clock.

### BRIEF DESCRIPTION OF THE DRAWINGS

FIG. 1a shows a hardware setup using two shift registers to form an inter-chip circular buffer.

FIG. 1b is a timing diagram for an SPI.

FIG. 2 is an embodiment of a typical memory read data path connection.

FIG. 3 shows a read data timing waveform for the typical data path connection.

FIG. 4 is an embodiment of a Memory Read Data Path for an SPI Memory.

FIG. 5 shows an embodiment of the read data timing using a peripheral clock.

### DETAILED DESCRIPTION OF THE EMBODIMENTS

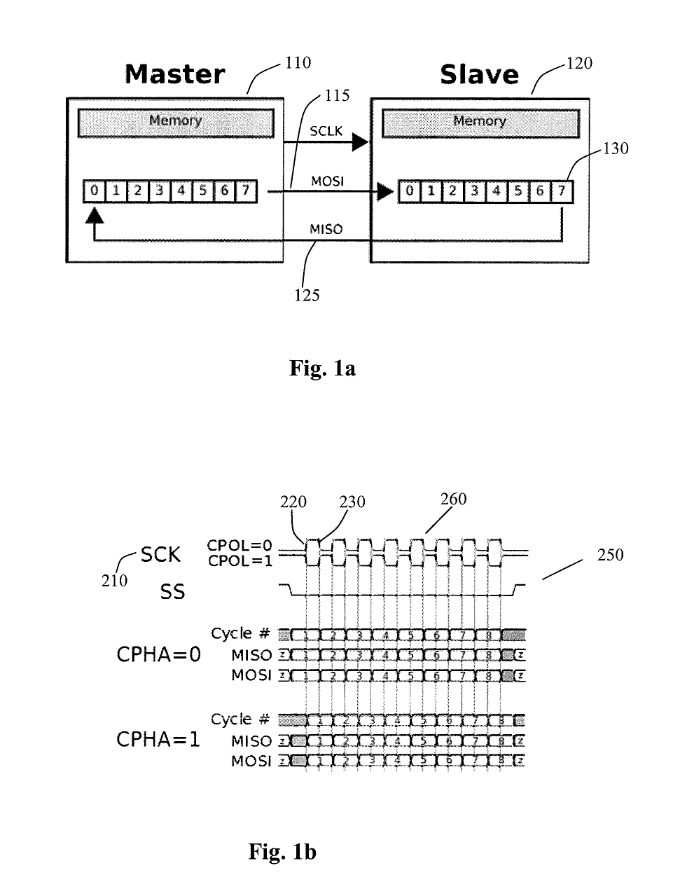

FIG. 1a shows a hardware setup using two shift registers to form an inter-chip circular buffer, as an example of an SPI master/slave configuration. To begin a communication, the bus master first configures the clock, using a frequency less than or equal to the maximum frequency the slave device supports. During each SPI clock cycle, a full duplex data transmission will occur. This means that the master 110 will send a bit on the MOSI line 115—and the slave 120 will read it from that same line. The slave will send a bit on the MISO line 125 and the master will read if from that same line. It is understood that not all transmissions require all four of these operations.

Transmissions may involve two shift registers 130 of some given word size, such as 8 bits. One register 130 is in the master 110 and one register is in the slave 120. Transmissions may involve any number of clock cycles. When data has completed transmission, the master 110 will stop toggling its clock.

The master 110 will set a clock frequency and configure a clock polarity and phase with respect to the data. CPOL and CPHA are respectively the conventional names used for these two options. FIG. 1b is a timing diagram for an SPI. Most SPI master modes have the ability to set the clock polarity (CPOL) and clock phase (CPHA) with respect to the data timing. The timing diagram 250 shows the clock for both values of CPOL as well as the values for two data lines (MISO and MOSI) for each value of CPHA. When CPHA=1, the data is delayed by one-half clock cycle.

The master determines an appropriate CPOL and CPHA value. The master pulls down the slave select (SS) line for a specific slave chip. The master clocks SCK at a specific frequency. During each of the 8 clock cycles 260, the transfer is full duplex. This means the master writes on the MOSI line and reads the MISO line during each cycle. The slave writes on the MISO and reads the MOSI line each cycle.

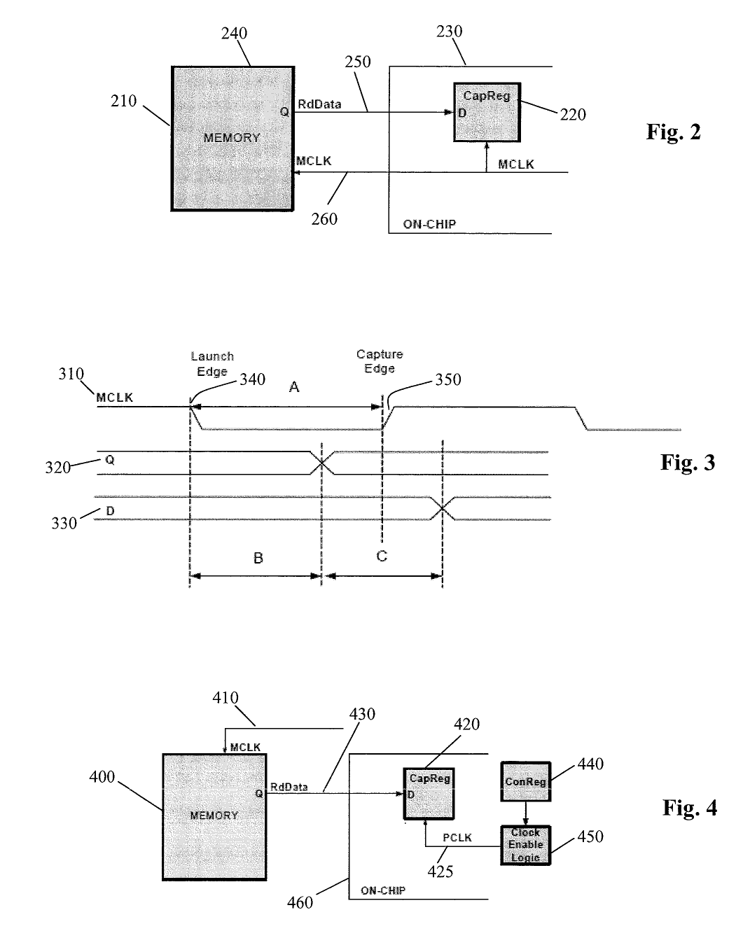

FIG. 2 is an embodiment of a typical memory read data path connection. A memory 210 is connected to a capturing register 220. The capturing register is located on a chip 230. The connection is via the output Q 240 and provides a read data signal 250 to the register D input 230. Both the memory 210 and the capturing register 220 are operating on the same clock (MCLK) 260.

FIG. 3 shows a read data timing waveform for the typical data path connection. There is a master clock (MLCK) 310, a memory output (Q) 320 and a capture register input signal D 330. As shown in FIG. 3, and in accordance with SPI protocols, at the falling edge 340 of the master clock MCLK 310, the read data Q 320 signal is launched by the memory. Likewise, the capturing register 220, input D, is triggered on the rising edge 350 of the master clock MCLK 350. A half period of the master clock is denoted at symbol A. A full cycle of the master clock is twice that of A. Symbol B denotes memory CLK to Q delay, which is the data availability at memory output Q 240 after the falling edge of MCLK 340. Symbol C is an on-chip delay. The on-chip delay represents PAD delay and memory input combinational logic delay.

Memory data is captured correctly when the period of A is greater to that of the period of B+the period of C. This leads to reduced memory operating frequency and an increased boot loader down load time.

FIG. 4 is an embodiment of a Memory Read Data Path for an SPI Memory. A memory 400 receives an input from a Master Clock, MCLK 410. A capturing register 420 receives an input from the memory 400 via a read data line 430. The capturing register operates on a peripheral clock PCLK 425 generated from a clock enable logic 450. A configurable register 440 is programmable and controls the PCLK 425 enable logic to the capture register 420. The configurable register 440 enables the capture register PCLK based on memory read data path delay. The capture register 420, configurable register and clock enable logic 450 are on-chip 460.

The capture register 420 operates on the peripheral clock PCLK 425 and the memory 400 operates on the master clock MCLK 410. The peripheral clock PCLK 425 operates at a higher frequency than the master clock MCLK 410. The peripheral clock PCLK and the master clock MCLK are both synchronous to each other.

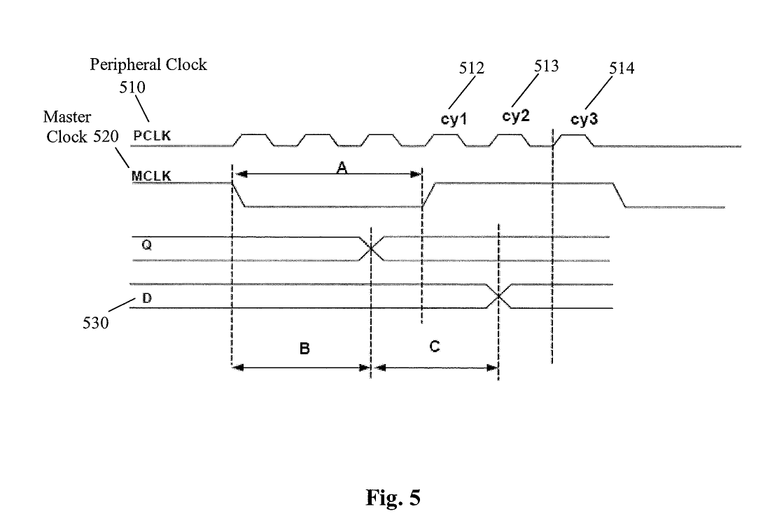

FIG. 5 shows an embodiment of the memory read data timing using a peripheral clock PCLK. The additional waveform for the peripheral clock PCLK 510 is shown. As noted above, the peripheral clock PCLK 510 operates synchronous to the master clock MCLK 520 and at a higher frequency. As shown in FIG. 4, the peripheral clock PCLK 510 operates at a frequency 6 times faster than the master clock MCLK 520. It is understood that different relationships of frequencies, such as where PCLK 510 operates 8 times faster than MCLK 520 are possible. The PCLK cycles during the time when MCLK is high are labeled sequentially as cy1 512, cy2 513 and cy3 514.

The memory read data is captured by the peripheral clock PCLK 510 rather than by the master clock MCLK 520. As PCLK 510 operates at a higher frequency, memory read data path can be captured at multiple rising edges of PCLK 510 during MCLK 520 high times. This can be based on the read data availability at the capture register D 530. In the waveform, PCLK cycle cy3 514 is the first available period to capture read data at the capture register input D 530 The memory can be operated at a rated frequency successfully even if the read data path delay is higher than the memory half clock period. The configure register 440 of FIG. 4 may be programmed as a value of ‘3’ to capture read data in cy3 514 as shown in FIG. 5.

The foregoing description of the invention has been presented for purposes of illustration and description. It is not intended to be exhaustive or to limit the invention to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

What is claimed is:

1. A system for capturing data when a flash memory is interfaced with on-chip devices, said system comprising:
a flash memory with a read-data output; and
an on-chip capture register;
wherein the memory operates on a master clock and the capture register operates on a peripheral clock, said peripheral clock operating at a higher frequency than said master clock and synchronous to said master clock, and read data is captured by the capture register on a cycle of the peripheral clock when the master clock is high and read data is available at the capture register.

2. The system of claim 1, further comprising a clock enable logic and a configurable register, wherein said configurable register provides an input to the clock enable logic and said clock enable logic provides the peripheral clock to the capture register.

3. The system of claim 2, wherein said configurable register is programmable to capture data at the capture register at a predetermined cycle.

4. The system of claim 1, where in read data output is a single signal.

5. The system of claim 1, wherein read data output is a set of signals

6. The system of claim 1, where in capture register, flash memory can both be located on chip

7. The system of claim 1, wherein the peripheral clock operates faster at a frequency integer multiple to the master clock.

8. The system of claim 1, wherein the peripheral clock operates faster at a frequency non-integer multiple to the master clock.

9. The system of claim 8, further comprising a clock enable logic and a configurable register, wherein said configurable register provides an input to the clock enable logic and said clock enable logic provides the peripheral clock to the capture register.

10. The system of claim 9, wherein said configurable register is programmable to capture data at the capture register at a predetermined cycle.

11. A method of capturing data when a flash memory is interfaced with on-chip devices, said method comprising:
operating the memory with a master clock;
operating a capture register located on-chip with a peripheral clock; and
capturing read data by the capture register on a cycle of the peripheral clock when the master clock is high and read data is available at the capture register;
wherein the peripheral clock is synchronous with the master clock and operates at a higher frequency than the master clock.

12. The method of claim 11, wherein the peripheral clock operates faster at a frequency integer multiple to the master clock.

13. The method of claim 11, further comprising generating the peripheral clock with a clock enable logic controlled by a configurable register, said logic and said configurable register being on-chip.

14. The method of claim 13, wherein the peripheral clock operates faster at a frequency integer multiple to the master clock.
